(19) United States
(12) Patent Application Publication
(10) Pub. No.: US 2012/0187303 A1
(43) Pub. Date: Jul. 26, 2012

(54) RADIOGRAPHIC IMAGING DEVICE, COMPUTER READABLE MEDIUM STORING RADIOGRAPHIC IMAGING PROGRAM, AND RADIOGRAPHIC IMAGING METHOD

(75) Inventor: Yoshihiro OKADA, Kanagawa (JP)

(73) Assignee: FUJIFILM CORPORATION, Tokyo (JP)

(21) Appl. No.: 13/338,281

(22) Filed: Dec. 28, 2011

(30) Foreign Application Priority Data
Jan. 21, 2011 (JP) 2011-010994

(51) Int. Cl. G01T 1/24

(52) U.S. Cl. 250/370.08

(57) ABSTRACT

The present invention provides a radiographic imaging device, a computer readable storage medium storing a radiographic imaging program, and a radiographic imaging method, that may appropriately reduce remaining charges of a photoelectric conversion element. Namely, when radiation is irradiated, an amplifier is switched to a sampling state, TFT switches are switched to an ON state, and charges that have been generated due to the radiation are read out for generating image data of a radiographic image. After an S/H switch has been turned ON for a specific duration and charges has been output to an ADC, the TFT switches are again switched to the ON state in a period outside the CA sampling period, and charges read out from sensor sections by the TFT switch are read-discarded without being employed for the generation of image data.

### CROSS-REFERENCE TO RELATED APPLICATION

This application claims priority under 35 USC 119 from Japanese Patent Application No. 2011-010994, filed on Jan. 21, 2011 the disclosure of which is incorporated by reference herein.

### BACKGROUND OF THE INVENTION

1. Field of the Invention

The present invention relates to a radiographic imaging device, a computer readable medium storing a radiographic imaging program, and a radiographic imaging method. The present invention relates particularly to a radiographic imaging device, a computer readable medium storing radiographic imaging program and a radiographic imaging method, for imaging a medical radiographic image.

2. Description of the Related Art

Radiographic imaging devices that perform radiographic imaging for medical diagnostic purposes are known. In such a radiographic imaging device, radiation irradiated from a radiation irradiation device and that has passed through an investigation subject is detected, and a radiographic image is imaged. Radiographic imaging is performed in such a radiographic imaging device by collecting and reading out charges generated according to the irradiation of radiation.

Such a radiographic imaging device is provided with a radiation detection element for detecting radiation. As such a radiation detection element that is a radiation detection element including a photoelectric conversion element that generates charges when irradiated with radiation or illuminated with light that has been converted from the radiation, and a switching element that read out the accumulated charges that was generated in the photoelectric conversion element.

There are cases in which remaining charges remains in the photoelectric conversion element even after charges have been read out from the photoelectric conversion element. For example, according to a conventional technique described in Japanese Patent Application Laid-Open (JP-A) No. 2005-287773, charges are not sufficiently read out from a photoelectric conversion element due to having to reset an amplifier that amplifies charges read out from the photoelectric conversion element, acquire a reference electrical potential and perform signal processing on acquired charge data, all during a period from when a charge read-out period ends until when the read-out period for charges from the next row begins. Charges that are not read out remains as remaining charges in the photoelectric conversion elements (see FIG. 11).

In particular, when there is insufficient driving ability for the switching elements to read out the charges generated in the photoelectric conversion elements, charges remains in the photoelectric conversion element (remaining charges). When a radiographic image is imaged in a state having remaining charges, the remaining charges are superimposed on the imaged image data, resulting what is known as an afterimage. There is therefore demand for a technique to reduce the remaining charges.

Techniques generally performed for reducing remaining charges may, for example, lengthen the charge read-out period of the switching element, and increase the size of the switching elements. There is also a conventional technique described in JP-A No. 2010-005121 that perform a refresh operation on a photoelectric conversion element in order to suppress afterimage. In this technique, after charges are read out from the photoelectric conversion element, the switching elements are again switched to an ON state, the reference electrical potential of an amplifier that amplifies charges read out from the photoelectric conversion elements with respect to the reference electrical potential switched to High Level, and a positive bias is applied to the photoelectric conversion elements.

However the conventional technique described in JP-A No. 2005-287773 may lower the frame rate due to lengthening the charges read-out period of the switching elements, as described above.

The conventional technique described in JP-A No. 2010-005212 is directed towards switching the reference electrical potential of the amplifier to High Level, and applying a positive bias to the photoelectric conversion elements, and therefore remaining charges are not reduced (see FIG. 12).

### SUMMARY OF THE INVENTION

The present invention provides a radiographic imaging device, a computer readable storage medium storing a radiographic imaging program, and a radiographic imaging method, that may appropriately reducing remaining charges in photoelectric conversion elements.

A first aspect of the present invention is a radiographic imaging device including: a plurality of pixels disposed in a matrix, each pixel including: a photoelectric conversion element that generates charges due to irradiation of radiation, and a switching element that reads out the charges from the photoelectric conversion element and outputs the charges; an amplification section that accumulates the charges output from the switching element and that outputs an amplified electrical signal of the accumulated charges; and a control section that switches the switching element to an ON state, and after performing a read-out operation that read out the amplified electrical signal, performs a read-discard operation that again switches the switching element to the ON state during a period outside of a charge accumulation period of the amplification section, and that read-discards the amplified electrical signal of charges that was not read out during the read-out operation.

After performing the read-out operation in order to generate image data for a radiographic image, by switching the switching element to an ON state and reading out charges from the photoelectric conversion elements as the electrical signal amplified by the amplification section, charges may remain in the photoelectric conversion element that was not completely read out, so called remaining charges.

According to the present invention, after the control section has performed the read-out operation switching the switching element to the ON state and reading out the signal amplified by the amplification section, the control section performs the read-discard operation that again switches the switching element to the ON state, this time during a period outside of the charge accumulation period of the amplification section, and read-discards the amplified electrical signal of charges that was not read out during the read-out operation.

Accordingly, due to the present invention performing the read-discard operation, similar circumstances are achieved cases in which the switching element ON duration is extended, and appropriate remaining charges reduction may be achieved.

A second aspect of the present invention, in the first aspect, the control section may perform the read-discard operation on the electrical signal for a plurality of rows of pixels at the same timing.

In a third aspect of the present invention, in the above aspects, the control section may perform the read-discard operation on the electrical signal a plurality of times for the same pixel.

In a fourth aspect of the present invention, in the above aspects, the control section may perform the read-discard operation on the electrical signal during a reset period in which the amplification section discharges the accumulated charges.

A fifth aspect of the present invention is a computer readable storage medium storing a radiographic imaging program for causing a computer to execute a process for radiographic imaging in a radiographic imaging device including, a plurality of pixels disposed in a matrix, each pixel including, a photoelectric conversion element that generates charges due to irradiation of radiation, and a switching element that reads out the charges from the photoelectric conversion element and outputs the charges, and an amplification section that accumulates the charges output from the switching element and outputs an amplified electrical signal of the accumulated charges, the process including: performing a read-out operation that switches the switching element to an ON state and that read out the electrical signal amplified by the amplification section; and performing a read-discard operation, after performing the read-out operation, that again switches the switching element to the ON state during a period outside of the charge accumulation period of the amplification section, and read-discards an amplified electrical signal of charges that was not read out during the read-out operation.

A sixth aspect of the present invention is a radiographic imaging method for radiographic imaging in a radiographic imaging device including, a plurality of pixels disposed in a matrix, each pixel including, a photoelectric conversion element that generates charges due to irradiation of radiation, and a switching element that reads out the charges from the photoelectric conversion element and outputs the charges, and an amplification section that accumulates the charges output from the switching element and outputs an amplified electrical signal of the accumulated charges, the method including: performing a read-out operation that switches the switching element to an ON state and that read out the electrical signal amplified by the amplification section; and performing a read-discard operation, after performing the read-out operation, that again switches the switching element to the ON state during a period outside of the charge accumulation period of the amplification section, and read-discards an amplified electrical signal of charges that was not read out during the read-out operation.

As explained above, the above aspects of the present invention may appropriately reduce the remaining charges in the photoelectric conversion elements.

### BRIEF DESCRIPTION OF THE DRAWINGS

Exemplary embodiments of the present invention will be described in detail based on the following figures, wherein:

FIG. 1 is a schematic diagram illustrating a configuration of a radiographic imaging system according to a first exemplary embodiment;

FIG. 2 is a configuration diagram illustrating the overall configuration of a radiographic imaging device according to the first exemplary embodiment;

FIG. 3 is a plan view illustrating a configuration of a radiation detection element according to the first exemplary embodiment;

FIG. 4 is a cross-sectional view of a radiation detection element according to the first exemplary embodiment;

FIG. 5 is a schematic diagram illustrating a schematic configuration of a signal detection circuit of a radiographic imaging device according to the first exemplary embodiment;

FIG. 6 is a timing chart illustrating a flow of operation when imaging a radiographic image with a radiographic imaging device according to the first exemplary embodiment;

FIG. 7 is a timing chart illustrating an another flow of operation when imaging a radiographic image with a radiographic imaging device according to the first exemplary embodiment;

FIG. 8 is a timing chart illustrating an another flow of operation when imaging a radiographic image with a radiographic imaging device according to the first exemplary embodiment;

FIG. 9 is a schematic diagram illustrating a schematic configuration of a signal detection circuit of a radiographic imaging device according to a second exemplary embodiment;

FIG. 10 is a timing chart illustrating a flow of operation executed when imaging a radiographic image with a radiographic imaging device according to the second exemplary embodiment;

FIG. 11 is a timing chart illustrating a flow of operation when imaging a radiographic image with a conventional radiographic imaging device; and

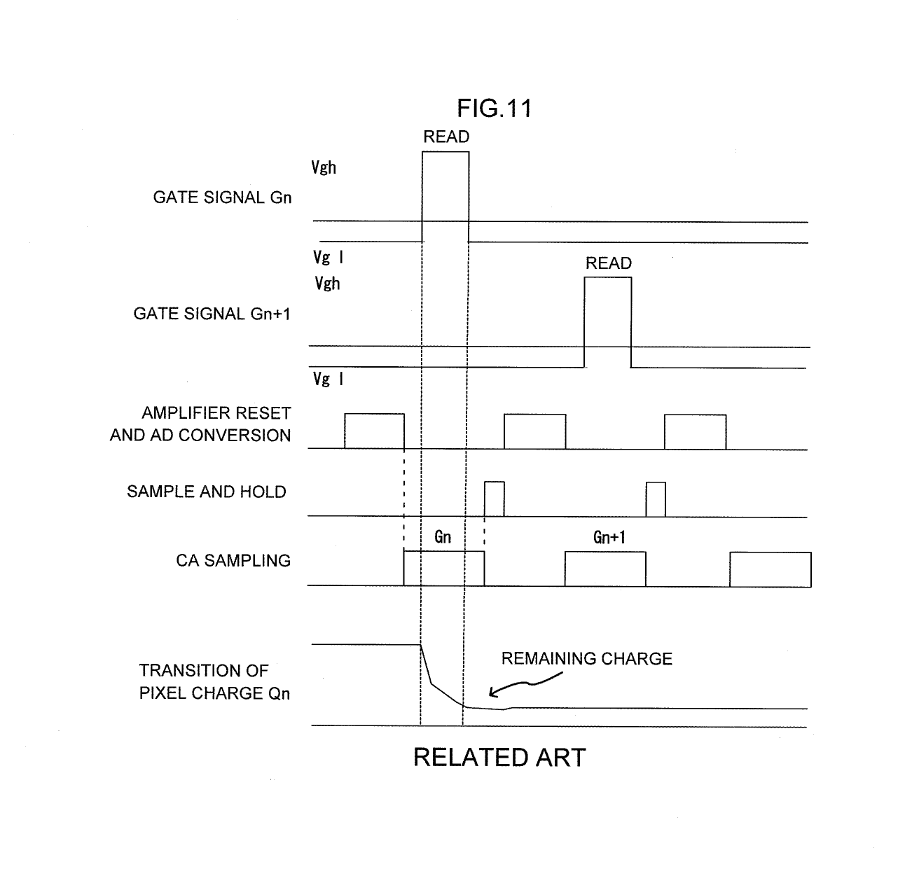

FIG. 12 is a timing chart illustrating a flow of operation when imaging a radiographic image with a conventional radiographic imaging device.

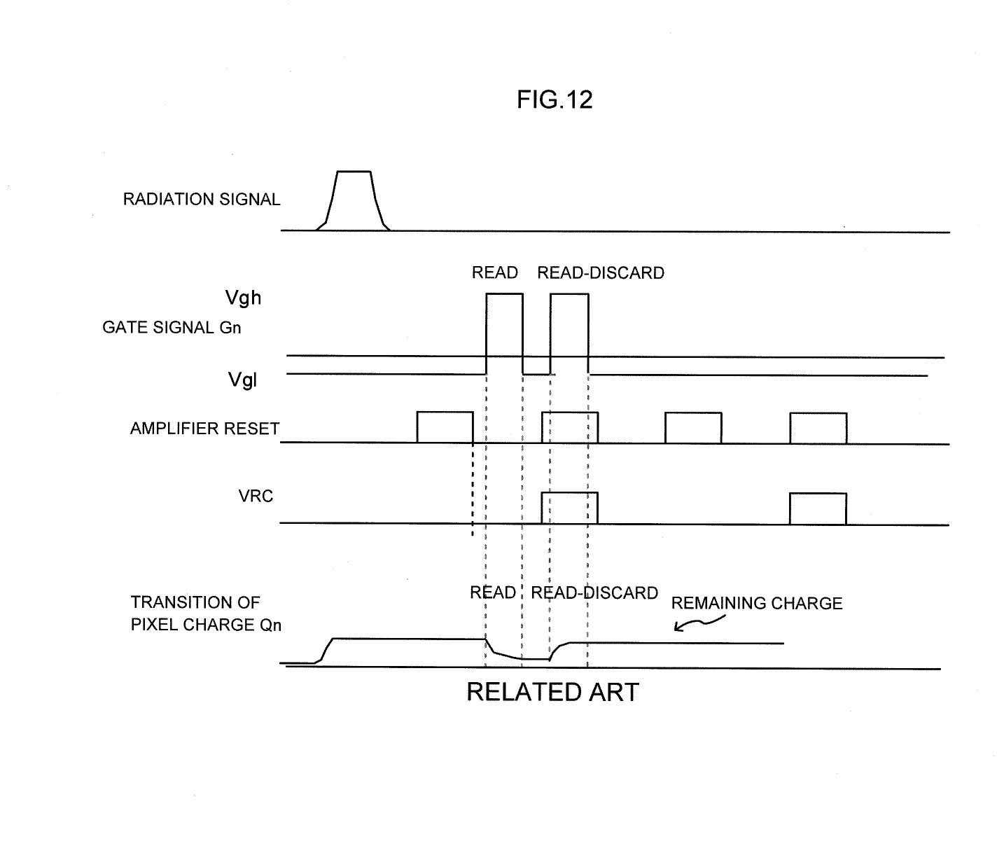

### DETAILED DESCRIPTION OF THE INVENTION

### First Exemplary Embodiment

Explanation follows regarding an exemplary embodiment, with reference to the drawings.

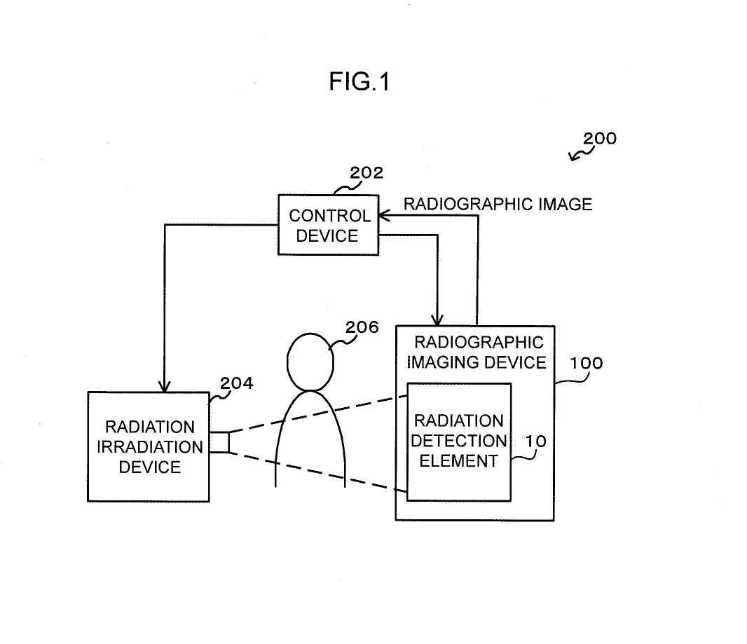

Hereinafter, explanation will be given regarding a schematic configuration of a radiographic imaging system in which a radiographic imaging device of the present exemplary embodiment is employed. FIG. 1 is a schematic diagram of an example of a radiographic imaging system of the present exemplary embodiment.

A radiographic imaging system 200 is configured with: a radiation irradiation device 204 for irradiating radiation (such as X-rays) onto an investigation subject 206; a radiographic imaging device 100 equipped with a radiation detection element 10 for detecting radiation that was irradiated from the radiation irradiation device 204 and has passed through the investigation subject 206; and a control device 202 for issuing radiographic imaging instructions and for acquiring a radiographic image from the radiographic imaging device 100. Radiation irradiated from the radiation irradiation device 204 at a timing under control of the control device 202 passes through the investigation subject 206 positioned at an imaging position, thereby picking up image data, and is irradiated onto the radiographic imaging device 100.

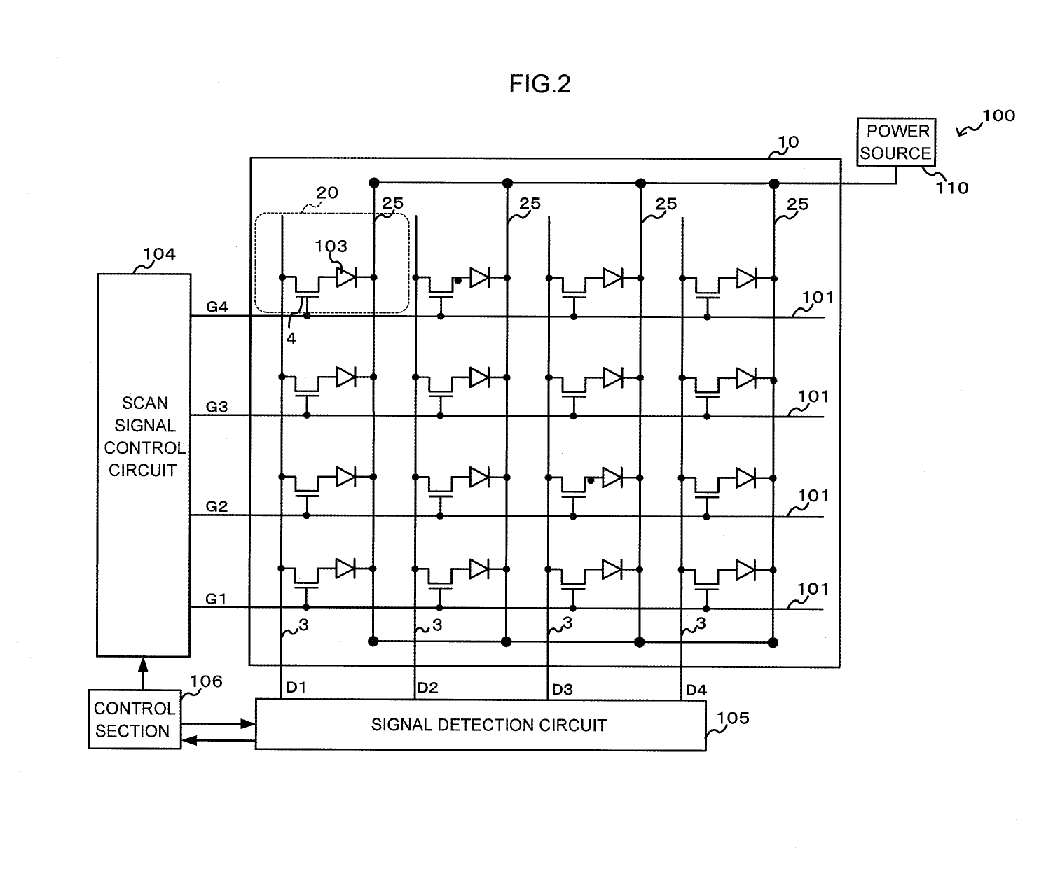

Hereinafter, explanation will be given regarding a schematic configuration of the radiographic imaging device 100 of the present invention referred to above. In the present exemplary embodiment, a case in which the present invention is applied to an indirect-conversion-type of radiation detection element 10 in which radiation such as X-rays is first converted into light, and the converted light is then converted into charges. In the present exemplary embodiment the radiographic imaging device 100 is configured with the radiation detection element 10 of an indirect-conversion-type. Note that a scintillator for converting radiation into light is omitted in FIG. 2.

Plural pixels 20 are arrayed in a matrix in the radiation detection element 10. Each of the pixels 20 includes a sensor section 103 that receives light, generates charges and accumulates the generated charges, and a TFT switch 4 that is a switching element for reading out the charges accumulated in the sensor section 103. In the present exemplary embodiment the sensor sections 103 generates charges due to illumination of light that has been converted by the scintillator.

The plural pixels 20 are disposed, in a matrix, along a specific direction (the across direction in FIG. 2, referred to below as “row direction”), and a direction orthogonal to the row direction (the vertical direction in FIG. 2, referred to below as “column direction”). The array of the pixels 20 is simplified in FIG. 2, however an example is an array with 1024×1024 individual pixels 20 disposed respectively in the row direction and the column direction.

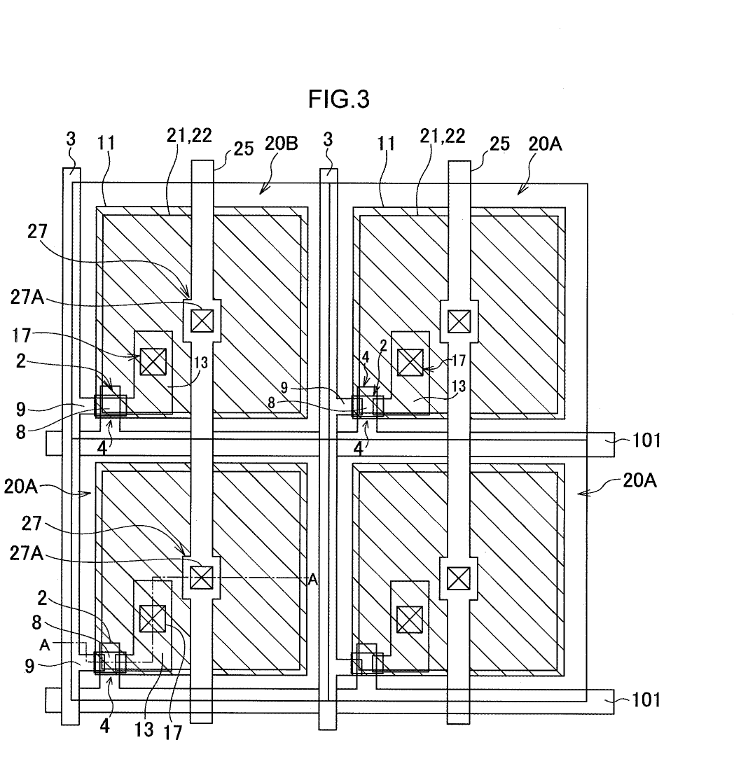

In the radiation detection element 10 plural scan lines 101 are provided on a substrate 1 (see FIG. 3) for switching the TFT switched 4 ON or OFF, and plural signal lines 3 are provided orthogonal to the scan lines 101 for reading out charges accumulated in the sensor sections 103. In the present exemplary embodiment there is a single signal line 3 provided along the specific direction for each pixel row, and there is a single scan line 101 provided along the orthogonal direction for each pixel row. For example, when there are 1024×1024 individual pixels 20 respectively in the row direction and the column direction there are also 1024 signal lines 3 and 1024 scan lines 101 provided.

Common electrode lines 25 are provided alongside the signal lines 3 in the radiation detection element 10. The first ends and second ends of the common electrode lines 25 are connected together in parallel, with the first ends connected to a power source 110 supplying a specific bias voltage. The sensor sections 103 are connected to the common electrode lines 25 and are applied with a bias voltage through the common electrode lines 25.

Control signals for switching each of the TFT switches 4 flow in the scan lines 101. Each of the TFT switches 4 are switched by the control signals flowing in each of the scan lines 101.

Electrical signals corresponding to the charges that have been accumulated in each of the pixels 20 flow in the signal lines 3 depending on the switching state of each of the TFT switches 4 of the pixels 20. More specifically, switching ON the TFT switch 4 of the pixel 20 connected to a given signal line 3 results in an electrical signal flowing in the given signal line 3 corresponding to the charges that was accumulated in the pixel 20.

The signal lines 3 are connected to a signal detection circuit 105 for detecting the electrical signals flowing out of each of the signal lines 3. The scan lines 101 are connected to a scan signal control circuit 104 for outputting to each of the scan lines 101 control signals for switching the TFT switches 4 ON or OFF. In FIG. 2, simplification has been made to a single of the signal detection circuit 105 and a single of the scan signal control circuit 104, however for example plural of the signal detection circuits 105 and the scan signal control circuits 104 are provided, each connected to a specific number (for example 256) of the signal lines 3 or the scan lines 101. For example when there are 1024 lines provided for both the signal lines 3 and the scan lines 101, four of the scan signal control circuits 104 are provided connected one for every 256 of the scan lines 101, and four of the signal detection circuits 105 are provided connected one for every 256 of the signal lines 3.

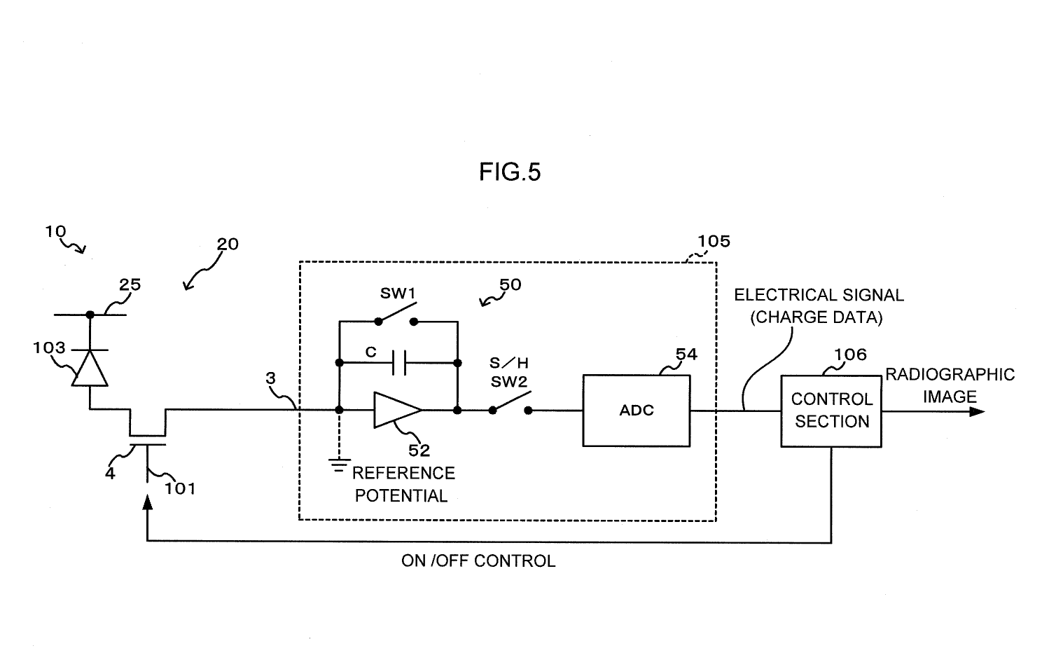

The signal detection circuit 105 is installed with an amplification circuit (amplification circuit 50, see FIG. 5) for each of the signal lines 3 to amplify input electrical signals. In the signal detection circuit 105, each of the electrical signals input from the signal lines 3 is amplified by the amplification circuit and is converted to a digital signal by an analogue-to-digital converter (ADC).

A control section 106 is connected to the signal detection circuits 105 and the scan signal control circuits 104. The control section 106 performs specific process, such as noise reduction process, on the digital signals converted in each of the signal detection circuits 105, outputs a control signal to each of the signal detection circuits 105 instructing a timing for signal detection, and outputs to each of the scan signal control circuit 104 a control signal instructing a timing for output of scan signals.

The control section 106 in the present exemplary embodiment is configured by a microcomputer including a Central Processing Unit (CPU), ROM and RAM, and a nonvolatile storage section such as flash memory. The control section 106 then generates an image expressing irradiated radiation based on the electrical signals that have been input from the signal detection circuits 105 expressing the charge data of each of the pixels 20 employed for radiation detection.

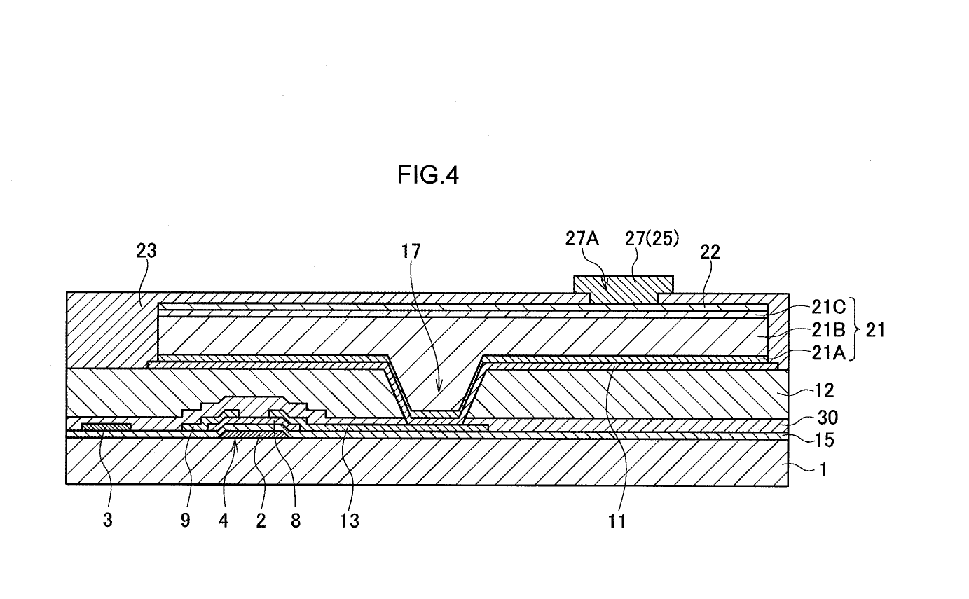

FIG. 3 is a plan view illustrating a structure of the indirect conversion type radiation detection element 10 according of the present exemplary embodiment. FIG. 4 is a cross-sectional view of a radiographic imaging pixel 20A of FIG. 3, taken along line A-A.

As shown in FIG. 4, each pixel 20A of the radiation detection element 10 has a scan line 101 (see FIG. 3) and a gate electrode 2 formed on the insulating substrate 1 of a material such as alkali-free glass, with the scan line 101 and the gate electrode 2 connected together (see FIG. 3). The wiring layer in which the scan lines 101 and the gate electrodes 2 are formed (this wiring layer is referred to below as the first signal wiring layer) is formed with Al and/or Cu, or with a layered film with a main component of Al and/or Cu, however there is no limitation thereto.

An insulation film 15 is formed on one face of the first signal wiring layer, and portions of the insulation film 15 above the gate electrodes 2 act as a gate insulation film in the TFT switches 4. The insulation film 15 is formed, for example, from SiNₓ by, for example, Chemical Vapor Deposition (CVD) film forming.

An island shape of a semiconductor active layer 8 is formed above the insulation film 15 on the gate electrode 2. The semiconductor active layer 8 is a channel portion of the TFT switch 4 and is, for example, formed from an amorphous silicon film.

A source electrode 9 and a drain electrode 13 are formed in a layer above. The wiring layer in which the source electrode 9 and the drain electrode 13 are formed also includes the signal lines 3 formed with the source electrodes 9 the drain electrodes 13. The source electrode 9 is connected to the signal line 3 (see FIG. 3). The wiring layer in which the source electrodes 9, the drain electrodes 13 and the signal lines 3 are formed (this wiring layer is referred to below as the second signal wiring layer) is formed with Al and/or Cu, or with a layered film with a main component of Al and/or Cu. However, the material of the second signal wiring layer is not limited thereto. An impurity doped semiconductor layer (not shown in the drawings) is formed between the semiconductor active layer 8 and both the source electrode 9 and the drain electrode 13 from a material such as impurity doped amorphous silicon. The TFT switch 4 used for switching is configured by the above configuration. Note that in TFT switch 4, the source electrode 9 and the drain electrode 13 are reversed according to the polarity of the charges collected and accumulated by a bottom electrode 11, described later.

A TFT protection layer 30 to protect the TFT switches 4 and the signal lines 3 is formed covering the second signal wiring layer over substantially the whole of the region provided with the pixels 20 on the substrate 1 (substantially the entire region). The TFT protection layer 30 is formed, for example, from SiNₓ using, for example, CVD film forming.

A coated interlayer insulation film 12 is formed on the TFT protection layer 30. The interlayer insulation film 12 is formed by a low permittivity (specific permittivity εr=2 to 4) photosensitive organic material (examples of such materials include positive working photosensitive acrylic resins materials with a base polymer formed by copolymerizing methacrylic acid and glycidyl methacrylate, mixed with a naphthoquinone diazide positive working photosensitive agent) at a film thickness of 1 μm to 4 μm.

In the radiation detection element 10 according to the present exemplary embodiment, inter-metal capacitance between metal disposed in the layers above the interlayer insulation film 12 and below the interlayer insulation film 12 is suppressed to be small by the interlayer insulation film 12. Generally such materials also function as a flattening layer, exhibiting an effect of flattening out steps in the layers below. In the radiation detection element 10 of the present exemplary embodiment, a contact hole 17 is formed at a position corresponding to the interlayer insulation film 12 and the drain electrode 13 of the TFT protection layer 30.

The bottom electrode 11 of the sensor section 103 is formed above the interlayer insulation film 12 to cover the pixel region while also filling the contact hole 17. The bottom electrode 11 is connected to the drain electrode 13 of the TFT switch 4. When the thickness of a semiconductor layer 21, described later, is about 1 μm there are substantially no limitations to the material of the bottom electrode 11, as long as it is an electrically conductive material. The bottom electrode 11 may therefore be configured by a conductive metal such as an aluminum material or ITO.

However, when the film thickness of the semiconductor layer 21 is thin (about 0.2 to 0.5 μm), since there is insufficient light absorption in the semiconductor layer 21, an alloy or layered film with a main component of a light blocking metal is preferably employed for the bottom electrode 11 in order to prevent an increase in leak current occurring due to light illumination onto the TFT switch 4.

The semiconductor layer 21 functioning as a photodiode is formed over the bottom electrode 11. In the present exemplary embodiment, a PIN structure photodiode is employed for the semiconductor layer 21, with a n+ layer, i layer, and p+ layer (n+ amorphous silicon, amorphous silicon, p+ amorphous silicon), configured as layers of an n+ layer 21A, an i layer 21B, and a p+ layer 21C, in sequence from the lower layer. The i layer 21B generates charges (pairs of a free electron and a free hole) due to illumination of light. The n+ layer 21A and the p+ layer 21C function as contact layers, electrically connecting the i layer 21B to the bottom electrode 11 and to upper electrode 22, described below.

Individual upper electrodes 22 are respectively formed above each of the semiconductor layers 21. The upper electrodes 22 employ a material with high light transmissivity such as, for example, ITO or Indium Zinc Oxide (IZO). The radiation detection element 10 of the present exemplary embodiment is configured with the sensor sections 103, each configured to include the upper electrode 22, the semiconductor layer 21 and the bottom electrode 11.

A coated interlayer insulation film 23 is formed over the interlayer insulation film 12, the semiconductor layer 21 and the upper electrode 22. The interlayer insulation film 23 has an opening 27A facing a portion of each of the upper electrodes 22, and is formed so as to cover each of the semiconductor layers 21.

Common electrode wirings 25 are formed over the interlayer insulation film 23 with Al and/or Cu, or with an alloy or layered film with a main component of Al and/or Cu. The common electrode wirings 25 are each formed with a contact pad 27 in the vicinity of the opening 27A and are each electrically connected to the upper electrode 22 through the opening 27A in the interlayer insulation film 23.

In the radiation detection element 10 configured as described above, a protective film formed from an insulating material with low light absorption characteristics may also be employed as required, and the scintillator configured from a material such as GOS adhered to the surface using an adhesive resin with low light absorption.

Hereinafter, explanation follows regarding a schematic configuration of the signal detection circuit 105 of the present exemplary embodiment. FIG. 5 is a schematic diagram of an example of the signal detection circuit 105 of the present exemplary embodiment. The signal detection circuit 105 of the present exemplary embodiment is configured with the amplification circuit 50 and an analogue-to-digital converter (ADC) 54. Note that while simplified in the drawing of FIG. 5, one of the amplification circuits 50 is provided for each of the signal lines 3. Namely, the signal detection circuit 105 is provided with plural of the amplification circuits 50, with this being the same number as the number of the signal lines 3 of the radiation detection elements 10.

The amplification circuit 50 configuring a charge amplifier circuit is configured including an amplifier 52 such as an operational amplifier for amplifying charges based on a reference electrical potential, a capacitor C connected in parallel to the amplifier 52, and a switch SW1 employed for charge resetting also connected in parallel to the amplifier 52.

In the amplification circuit 50, charges (an electrical signal) is read by the TFT switch 4 of each pixel 20 with the charge reset switch SW1 in the OFF state, and charges that have been read out by the TFT switches 4 are accumulated in the condenser C, such that the voltage value output from the amplifier 52 is increased (raised) according to the amount of charges accumulated.

The control section 106 applies a charge reset signal to the charge reset switch SW1 to control switching ON or OFF of the charge reset switch SW1. The input side and the output side of the amplifier 52 are shorted when the charge reset switch SW1 is in the ON state, and the charges of the condenser C are discharged. The charges in the amplifier 52 are thereby reset (reset to ground level in the present exemplary embodiment)

When a sample and hold (S/H) switch SW5 is in an ON state the ADC 54 functions to convert analogue electrical signals input from the amplification circuit 50 into digital signals. The ADC 54 outputs the digitally converted electrical signals in sequence to the control section 106.

The ADC 54 of the present exemplary embodiment is input with electrical signals output from all of the amplification circuits 50 provided to the signal detection circuits 105. Namely, in the present exemplary embodiment, the signal detection circuit 105 is provided with a single ADC 54 irrespective of the number of the amplification circuits 50 (the number of the signal lines 3).

The control section 106 of the present exemplary embodiment has a function to switch the TFT switches 4 ON, read out the charge data for a radiographic image from the signal detection circuit 105 (ADC 54), and generate image data of the imaged radiographic image. After reading out the charge data, the control section 106 also has a read-discard function to again switch the TFT switches 4 ON in a period outside of the sample and hold period of the amplification circuit 50 of the signal detection circuit 105 (the period during which charges are accumulated in the condenser C), and to read-discard the charge data read-out from the sensor sections 103 by the TFT switches 4 and output from the signal detection circuit 105, without employing the charge data to generate image data for a radiographic image.

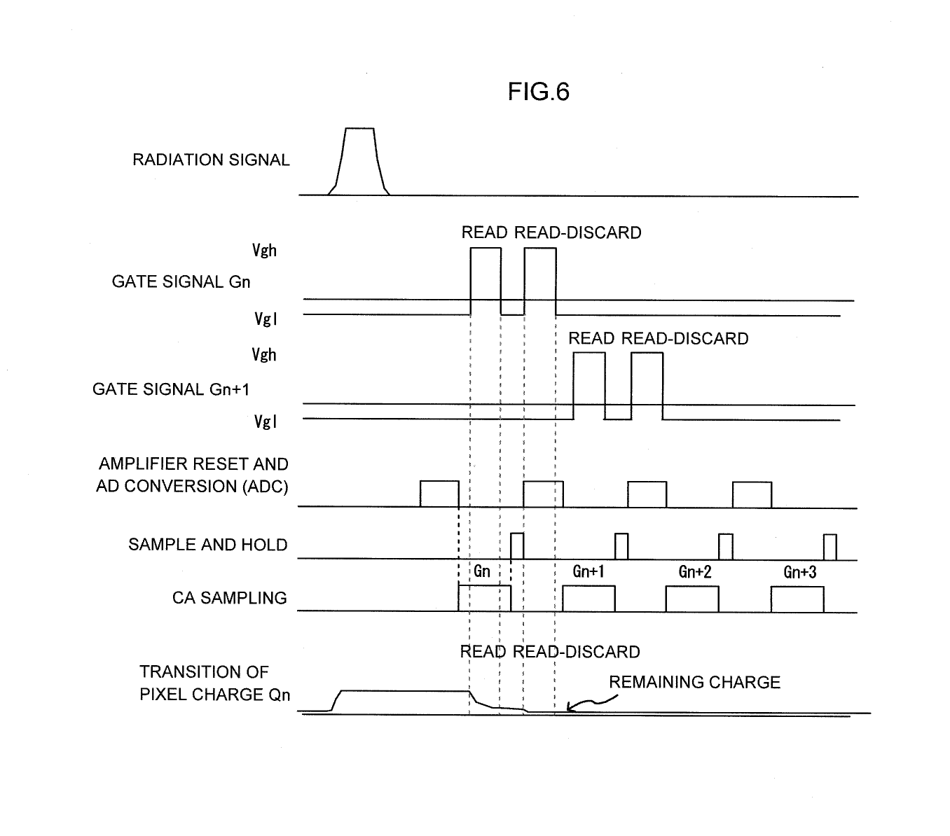

Hereinafter, explanation follows, with reference to FIG. 6, regarding a flow of operation during radiographic imaging with the radiographic imaging device 100 configured as described above, and focusing on operation to reduce the remaining charge. FIG. 6 is a timing chart illustrating an example of flow of operation during radiographic imaging. In the radiographic imaging device 100 of the present exemplary embodiment each of the operations during radiographic imaging are performed by row of the pixels 20 (by scan line 101).

When radiation is irradiated from the radiation irradiation device 204 (see the radiation signal of FIG. 6), the irradiated radiation is absorbed by the scintillator and is converted into visible light. Note that the radiation may be irradiated from either the front face or the back face of the radiation detection element 10. The radiation converted to visible light by the scintillator is then illuminated onto the sensor section 103 in each of the pixels 20.

Illumination with light results in charges being generated inside the sensor sections 103. The charges of the sensor sections 103 increases by the generated charges being collected by the bottom electrodes 11 (see the pixel charge Qn transition in FIG. 6).

First the charge reset switch SW1 of the amplification circuit 50 and the ADC 54 are switched to an ON state for a specific duration (see “amplifier reset” and “ad conversion” of FIG. 6). In the present exemplary embodiment, since the amplifier reset (the ON duration of the charge reset switch SW1) and AD conversion in the ADC 54 are both executed at the same time, these operations are both executed in the same period and for the same duration in order to raise the frame rate.

Then, in order to read out that charges that have been accumulated, CA sampling is switched to the ON state, and thereby charges are accumulated in the capacitor C of the amplification circuit 50. The gate signal Gn is also then set to Vgh, and the TFT switches 4 of one row's worth of the pixels 20 that are connected to the scan line 101 to which the gate signal Gn is input are switched to the ON state, and the charges that has been accumulated in the sensor section 103 are read out, and accumulated in the capacitor C of the amplification circuit 50 (see “read” in FIG. 6, referred to below as read operation).

When, after a specific read-out period has elapsed, the TFT switches 4 are switched to the OFF state and closed. When the read operation is ended, then the CA sampling becomes the OFF state.

Then a S/H switch SW2 is switched to the ON state for a specific duration, sampling is performed by the amplification circuit 50 to the ADC 54, and an amplified electrical signal is output.

When this occurs, pixel charge Qn transitions such as illustrated in FIG. 6, and charges that are not completely read out from the TFT switches 4 remains as remaining charges in the pixels 20 (the sensor sections 103).

In the present exemplary embodiment, after the sample and hold period has finished, the gate signal Gn is again set at Vgh for an amplifier reset duration for the amplifier 52, the TFT switches 4 are switched to the ON state, and the remaining charges are discharged using the TFT switches 4 (see the read-discard in FIG. 6). Note that the charges that have been read out are not employed as image data for a radiographic image, and are read-discarded by the control section 106 (referred to below as read-discard operation).

As explained above, in the radiographic imaging device 100 of the present exemplary embodiment, when radiation is irradiated, charges are generated due to the irradiation of radiation, the amplifier 52 is switched to the sampling state and the TFT switches 4 are also switched to the ON state, and charges for generating image data of a radiographic image is read out. Then, after the S/H switch SW2 has been switched to the ON state for a specific duration and charges has been output to the ADC 54, the TFT switches 4 are again switched to the ON state in a period outside of the CA sampling period, and remaining charges that has been read out from the sensor sections 103 by the TFT switches 4 is read-discarded without being employed for generating image data.

In the configured present exemplary embodiment, due to performing the read-discard operation to read-discard the remaining charges during a period (during an amplifier reset period of the amplifier 52 in the present exemplary embodiment) that is outside of the charge accumulation period of the condenser C of the amplifier 52 (CA sampling period), similar circumstances may be achieved to cases in which the ON duration of the TFT switches 4 is lengthened, and the remaining charges may be reduced.

In the present exemplary embodiment due to the read-discard operation also being performed in the amplifier reset period as described above, the remaining charges may be reduced without reducing the frame rate.

The radiographic imaging device 100 of the present exemplary embodiment, as described above, may not increase the size (capacity) of the TFT switches 4 and is particularly applicable to imaging requiring a fast frame rate (for example video imaging) since appropriate remaining charges reduction may be achieved without lowering the frame rate.

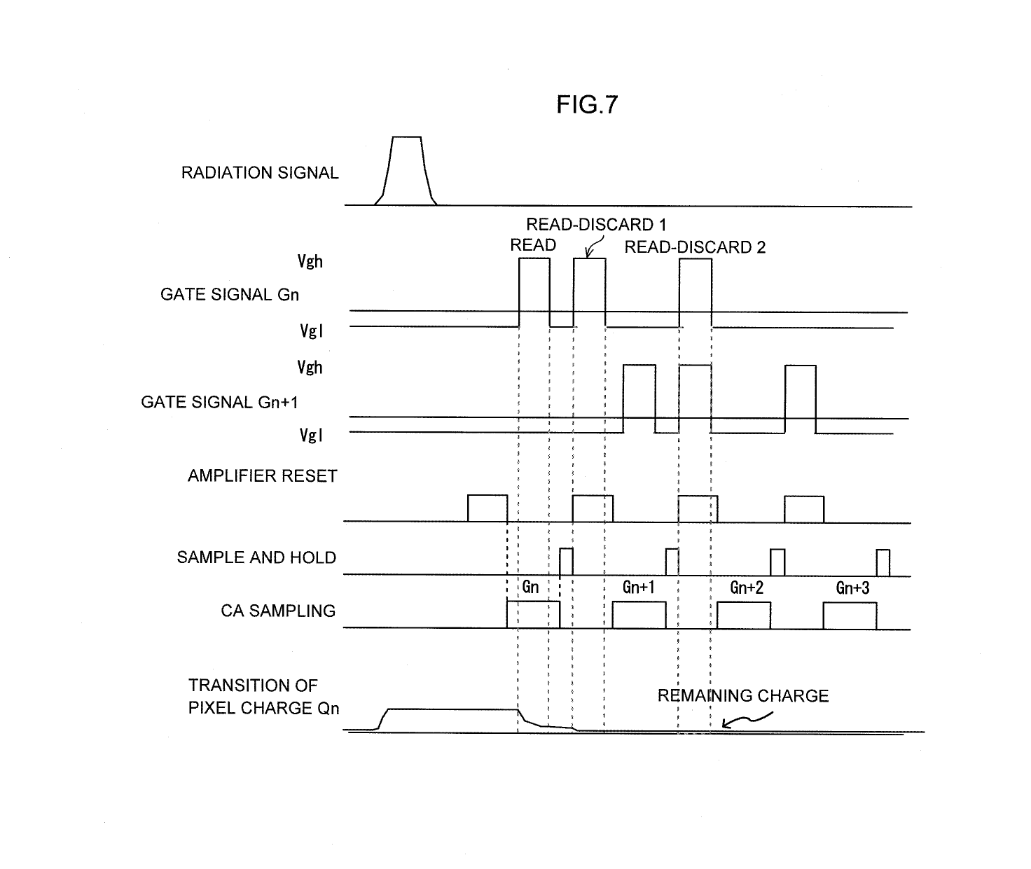

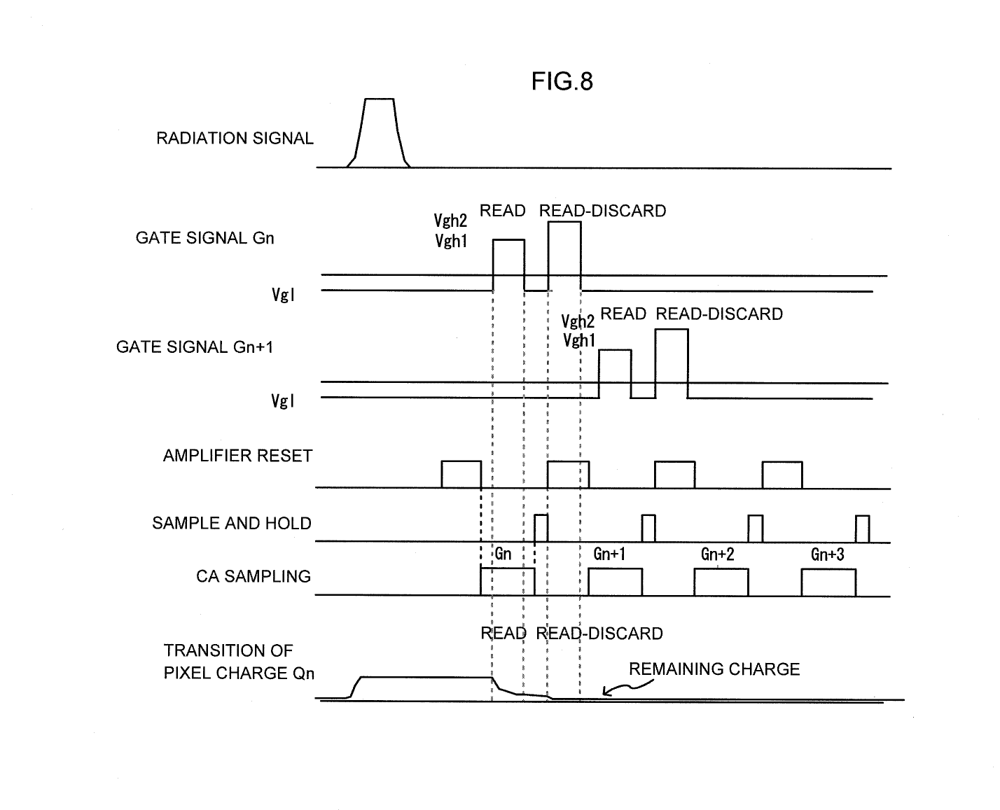

Note that each of the above operations, such as read-discard operation, are not limited to the example described above (FIG. 6). The read-discard operation may be performed in a period (the amplifier reset period for the amplifier 52 in the exemplary embodiment) outside of the charge accumulation period of the capacitor C of the amplifier 52 (CA sampling period) due to the disadvantages incurred by charges for generating image data of a radiographic image mixing with remaining charges were the read-discard operation to be performed during the CA sampling period. Explanation regarding examples of an another follow will be described with reference to FIG. 7 and FIG. 8. FIG. 7 and FIG. 8 are timing charts illustrating examples of another flow of operation when imaging a radiographic image.

In FIG. 7 a case is illustrated in which the read-discard operation is executed for plural rows of the pixels 20 at the same time. In the present exemplary embodiment, the read-discard operation is being performed for plural times to the sensor section 103 of a given pixel 20 (see read-discard 1, read-discard 2 in FIG. 7). Hence, remaining charges can be removed even more effectively from the sensor sections 103. There is no particular limitation to the number of times of performing the read-discard operation (to the number of rows read-discard operation is performed at the same time) and the number of times can be predetermined to enable remaining charges to be removed.

FIG. 8 shows a case in which the gate voltage of the TFT switches 4 is different between the read operation and the read-discard operation. More specifically a case is shown in which the gate voltage Vgh2 during read-discard operation is higher than the gate voltage Vgh1 during read operation. The feed-through charges during read operation can be reduced by making the gate voltage applied to the TFT switches 4 during read-discard operation higher than the gate voltage during read operation, as well as enabling the time required for reducing the remaining charges to be shortened.

### Second Exemplary Embodiment

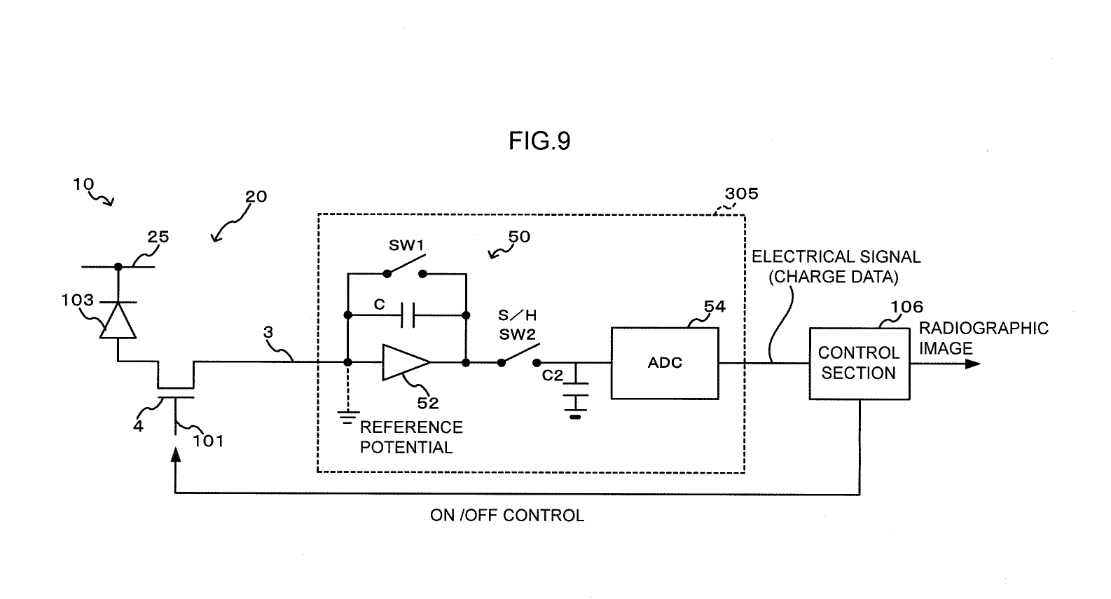

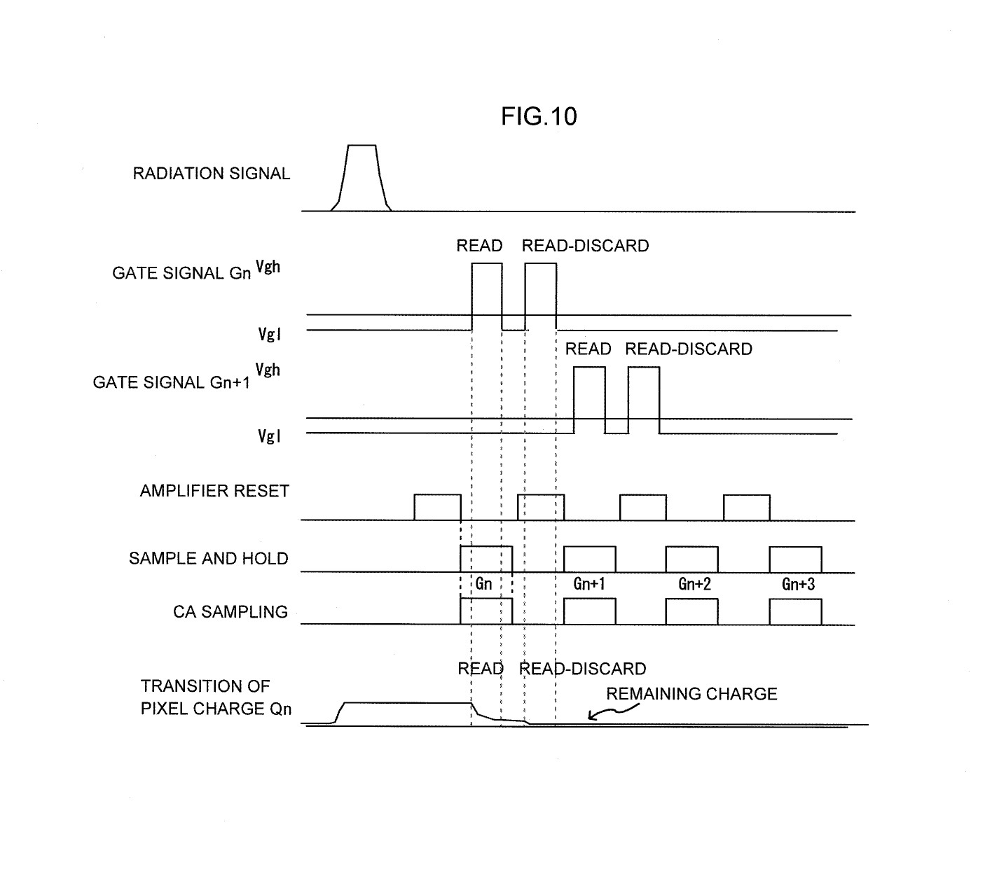

Explanation follows regarding an example of the second exemplary embodiment with reference to the drawings. The second exemplary embodiment is configured substantially the same as the first exemplary embodiment, however, the signal detection circuit of the radiographic imaging device and a portion of the radiographic image imaging operation are differing from the first exemplary embodiment. Portions that are similar to the first exemplary embodiment are allocated the same reference numerals and further explanation thereof is omitted. FIG. 9 is a schematic configuration diagram of an example of a signal detection circuit of the second exemplary embodiment. FIG. 10 is a timing chart illustrating an example of flow of operation during radiographic image imaging in the second exemplary embodiment.

In the signal detection circuit 305 of the second exemplary embodiment, the sample and hold period and the CA sampling period coincide with each other, and the sample and hold operation and CA sampling operation are performed at the same time. The signal detection circuit 305 is accordingly configured with a condenser C2 provided between the S/H switch SW2 and the ADC 54.

Explanation follows, with reference to FIG. 10, regarding the flow of operation during radiographic imaging in the second exemplary embodiment, focusing on operation to reduce the remaining charges

When radiation is irradiated from the radiation irradiation device 204, the charge reset switch SW1 of the amplification circuit 50 is switched to the ON state for a specific duration, and the amplifier 52 is reset.

Then, when the charge reset switch SW1 has been switched to the OFF state and the S/H switch SW2 has been switched to the ON state, the CA sampling period starts. Then, in order to read out the charges that has been accumulated in the sensor sections 103, the gate signal Gn is set to Vgh, the gates of the TFT switches 4 are switched to the ON state. According to the read operation, the charges Q accumulated in the sensor sections 103 are read out, and are employed to charge the condenser C of the amplification circuit 50, raising (amplifying) the output electrical potential of the amplifier 52.

When the read operation has been completed, the gates of the TFT switches 4 are switched to the OFF state. The S/H switch SW2 is also switched to the OFF state. The output electrical potential is thereby held.

The SW1 is then switched to the ON state, and the electrical potential inside the amplifier 52 is reset. During reset the gate signal Gn is again set to Vgh, the TFT switches 4 are switched to the ON state, and the remaining charges are read out by the TFT switches 4 and discharged (see read-discard in FIG. 10).

As explained above, in the second exemplary embodiment, similarly to in the first exemplary embodiment, the sample and hold period and the CA sampling period are made the same as each other, the sample and hold operation and the CA sampling operation are performed at the same time, and the TFT switches 4 are switched to the ON state, causing charges for generating image data of a radiographic image to be read out. Then in a period outside of the CA sampling period, the TFT switches 4 are again switched to the ON state, and the remaining charges read out from the sensor sections 103 by the TFT switches 4 are read-discarded without being employed for generating image data.

Accordingly, similarly to the first exemplary embodiment, the size (capacity) of the TFT switches 4 may be suppressed for increasing and appropriate remaining charges reduction may be achieved without lowering the frame rate.

The configurations and operations of the radiographic imaging device 100, the radiation detection element 10 and the like explained in the first exemplary embodiment and the second exemplary embodiment are merely examples. Obviously various changes are possible according to circumstances within a scope not departing from the spirit of the present invention.

There is no particular limitation to the radiation employed in the first exemplary embodiment and the second exemplary embodiment of the present invention, and radiation such as X-rays and gamma rays can be appropriately employed.

What is claimed is:

1. A radiographic imaging device comprising:
a plurality of pixels disposed in a matrix, each pixel comprising:
a photoelectric conversion element that generates charges due to irradiation of radiation, and
a switching element that reads out the charges from the photoelectric conversion element and outputs the charges;
an amplification section that accumulates the charges output from the switching element and that outputs an amplified electrical signal of the accumulated charges; and
a control section that switches the switching element to an ON state, and after performing a read-out operation that read out the amplified electrical signal, performs a read-discard operation that again switches the switching element to the ON state during a period outside of a charge accumulation period of the amplification section, and that read-discards the amplified electrical signal of charges that was not read out during the read-out operation.

2. The radiographic imaging device of claim 1, wherein the control section performs the read-discard operation on the electrical signal for a plurality of rows of pixels at the same timing.

3. The radiographic imaging device of claim 1, wherein the control section performs the read-discard operation on the electrical signal a plurality of times for the same pixel.

4. The radiographic imaging device of claim 1, wherein the control section performs the read-discard operation on the electrical signal during a reset period in which the amplification section discharges the accumulated charges.

5. A computer readable storage medium storing a radiographic imaging program for causing a computer to execute a process for radiographic imaging in a radiographic imaging device comprising, a plurality of pixels disposed in a matrix, each pixel comprising, a photoelectric conversion element that generates charges due to irradiation of radiation, and a switching element that reads out the charges from the photoelectric conversion element and outputs the charges, and an amplification section that accumulates the charges output from the switching element and outputs an amplified electrical signal of the accumulated charges, the process comprising:
performing a read-out operation that switches the switching element to an ON state and that read out the electrical signal amplified by the amplification section; and
performing a read-discard operation, after performing the read-out operation, that again switches the switching element to the ON state during a period outside of the charge accumulation period of the amplification section, and read-discards an amplified electrical signal of charges that was not read out during the read-out operation.

6. A radiographic imaging method for radiographic imaging in a radiographic imaging device comprising, a plurality of pixels disposed in a matrix, each pixel comprising, a photoelectric conversion element that generates charges due to irradiation of radiation, and a switching element that reads out the charges from the photoelectric conversion element and outputs the charges, and an amplification section that accumulates the charges output from the switching element and outputs an amplified electrical signal of the accumulated charges, the method comprising:
performing a read-out operation that switches the switching element to an ON state and that read out the electrical signal amplified by the amplification section; and
performing a read-discard operation, after performing the read-out operation, that again switches the switching element to the ON state during a period outside of the charge accumulation period of the amplification section, and read-discards an amplified electrical signal of charges that was not read out during the read-out operation.
